(19) United States
(12) Patent Application Publication
(10) Pub. No.: US 2015/0371294 A1
(43) Pub. Date: Dec. 24, 2015

(54) DISCRETE CLIENT BILLING

(71) Applicant: BLUE SENTRY, INC., Myrtle Beach, SC (US)

(72) Inventors: Kenneth Nolan JOHNSON, JR., Greensboro, NC (US); Larry Lee HYLTON, JR., High Point, NC (US); James Hugh BINGHAM, JR., Greensboro, NC (US)

(21) Appl. No.: 14/744,612

(22) Filed: Jun. 19, 2015

Related U.S. Application Data
(60) Provisional application No. 62/014,427, filed on Jun. 19, 2014.

(51) Int. Cl. G06Q 30/04

(52) U.S. Cl. CPC G06Q 30/04

(57) ABSTRACT

A method for discrete client billing is provided. In this method, a request to use network resources a network of an entity may be received. The action may be at least one of access, read, write, update, create, delete and/or store the file, and the network usage may be an expense to the entity. A first client associated with the network use request is identified. A total amount of network usage being performed for the first client during a predetermined cycle may be determined. A pro rata share of network usage for the first client during the cycle may be is determined based on a ratio of the total amount of network usage being performed for the first client during the cycle over a total amount of network usage being used by the entity during the cycle.

### CROSS-REFERENCE TO RELATED APPLICATIONS

This application claims the benefit of priority to U.S. Provisional Application No. 62/014,427, filed on Jun. 19, 2014, the entire contents of which is incorporated herein by reference in its entirety.

### BACKGROUND

For most legal, accounting, other professional firms or other companies that may bill, specifically track or allocate (collectively, “bill”) overhead expenses to their clients, internal divisions, subsidiaries, customers, venders, etc. (collectively, without limitation, a “client”) based on time and incurred expenses, information technology is often a fixed overhead cost that the firm/company must fully assume or absorb. Firms have traditionally charged clients only for operating expenses that can be associated with a particular client, such as long distance calls, faxes, photocopies, postage, filing fees, shelf or storage space, research expenses, or other operating costs with a direct measurable nexus to the client.

However, information technology may also be considered a firm expense that requires capital investment and ongoing overhead expense to maintain a firm-wide infrastructure that could not be allocated to specific clients due to various factors and complexities of quantifying information technology. In this way, information technology has not been viewed as an operating expense and has not been able to be covered by clients even though clients are the reason why the information technology costs increase/decrease.

### SUMMARY

Cloud computing models, in particular “Infrastructure as a Service” (IaaS), allow data processing, disk reads and writes (I/O), data storage, and network bandwidth to be billed as variable expenses. One pays for the quantity of each item used within a given period of time. In order to bill a particular client or other entity for the computing costs incurred while working for that particular client/other entity, a firm/company may be able to measure and analyze its computing activity relative to information technology, have a reasonable and relatively accurate client allocation method for that computing activity, and calculate an allocation of cloud computing expense to each client/other entity.

Embodiments of the present application described herein provides a, system (e.g., a software interface) that extracts user activity and data storage information from a firm's or company's computing environment and then attributes to a specific client the activity and data storage that is associated with that particular client/other entity. This may be accomplished without the use of internal billing codes on the part of the firm/company. An additional software interface extracts cloud computing charges from the IaaS vendor and applies the actual cost of computing activity and storage associated with each client, thereby allocating the expense among the firm's clients. This billing allocation is viewable by the firm and could interface directly with the firm's client time and billing system to generate line items on client bills.

According to one embodiment, a method for discrete client billing is provided. In this method, a request to use network resources a network of an entity may be received. The action may be at least one of access, read, write, update, create, delete and/or store the file, and the network usage may be an expense to the entity. A first client associated with the network use request is identified. A total amount of network usage being performed for the first client during a predetermined cycle may be determined. A pro rata share of network usage for the first client during the cycle may be is determined based on a ratio of the total amount of network usage being performed for the first client during the cycle over a total amount of network usage being used by the entity during the cycle.

According to another embodiment, a system for discrete client billing may include a database, a memory, and a processor. The processor may be configured for receiving, at a server, a request to store a first file on a network of an entity; identifying a first client associated with the first file; identifying a first file size counter associated with the first client; receiving a request to store a second file on the network of the entity; identifying that the first client is associated with the second file; determining a first file size and second file size of the second file associated with the first client; incrementing the first file size counter by the first file size and the second file size in response to determining that the first and second file sizes are associated with the first client; determining the first client's pro rata share of network usage using a ratio of the first file size counter of the first client over a total amount file size stored for all clients by the entity during the cycle.

According to another embodiment, a method for discrete client billing may include: receiving, at a server, a request to perform an action for each of a plurality of files on a network of an entity, wherein the action comprises at least one of accessing, reading, writing, updating, creating, deleting and/or storing one or more files; identifying a first client associated with the plurality of files; summing the file sizes of the plurality of files that the action has been performed only for the first client during a predetermined cycle, resulting in a first client total file size; determining a second total file size of files that the action has been performed by the entity associated with the first client and other clients during a predetermined cycle; an determining a pro rata share of network usage for the first client using a ratio of the first client total file size over the second total file size.

### BRIEF DESCRIPTION OF THE DRAWINGS

Aspects of the present invention is further described in the detailed description which follows in reference to the noted plurality of drawings by way of non-limiting examples of embodiments of the present invention in which like reference numerals represent similar parts throughout the several views of the drawings and wherein:

FIG. 1 is a flow chart illustrating an overview of a method for discrete client billing according to one embodiment.

FIG. 2 is a flow chart illustrating a method for discrete client billing of storage usage according to one embodiment.

FIG. 3 is a flow chart illustrating a method for discrete client billing of computing usage according to one embodiment.

FIG. 4 is a system diagram for discrete client billing according to one embodiment.

FIG. 5 is another system diagram for discrete client billing according to one embodiment.

FIG. 6 is a diagram illustrating a combination of a method and system for discrete client billing according to one embodiment.

### DETAILED DESCRIPTION OF THE EMBODIMENTS

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

A overview of the present disclosure is provided below. It should be understood that the present application refers to a firm or company as the entity which is billing its information technology expenses. However, it should be understood that any entity may employ one or more embodiments of the present application and the present application should not be limited to companies or firms. Use of the term “firm” or “company” may refer to any entity and are only used for ease of description below.

Also, the billing of information technology expenses are described herein. Such expenses could be any expenses relating to items that are only present in the information technology field, in one embodiment. For example, in such embodiment, there may be expenses such as storage of data on a server (or other computer) on a cloud network, computing usage of a server/computer on a cloud network, input/output processing (“IOPS”) performed by a processor of a server/computer on a cloud network, bandwidth use on a cloud network, and any other parameter or item that can be used on a cloud network. It should be noted that these issues are born because of network environments and thus, the solution to such issue is based on the network environment. In other words, this is a network solution to a network problem.

### Brief Overview

A cloud environment is one in which remote computing resources are metered and charged for according to the amount of bandwidth, compute, storage and input output operations per second utilized by the user. A user establishes a connection with a remote computer server in such an environment and begins creating, reading, updating, deleting or otherwise accessing computer files/network features in the network environment. These actions by the user are referred to as “CRUD” operations.

While this CRUD work is occurring, a computer program is monitoring the operating system of the computer waiting for CRUD operations to occur. When such an operation is called for the system/computer program responds by blocking the operating system's user interface and may interject the program's interface to the user (or automatically internally) in order to capture client and matter identifying data. Upon capturing these data from the user, the program writes the client/matter identification information along with the size of the file acted on, a date and time stamp and a user identifier to a database. This process may be repeated throughout a billing period/cycle for all users of the firm/company on the network as data is stored each time a CRUD operation occurs.

At the end of the billing period determined by a user, a report can be generated summing all of the file sizes by client identifier that were created, read, updated, deleted, accessed, etc. The sum of bytes operated on by all users on behalf of each client is then used to establish a pro-rata allocation to each client of a percentage of the total amount of data accessed within the cloud environment. This percentage of the total is used to allocate each client's pro-rata share of bandwidth charges, IOPS charges and compute charges. Storage charges for each client are calculated by summing the file sizes that were stored at the beginning of the period, plus any that were created times the number of days they were stored during the period, minus any deleted file sizes times the number of days the deleted files were no longer stored during the period. The total of bandwidth, compute, storage and IOPS charges are then summed for each client and an itemized bill showing the total dollar amounts of cloud computing charges that were incurred for each client is generated.

Substantially all of the computing activity on client matters in professional firms/companies is centered on the production, editing and saving of documents, including emails, Word documents, PDF images, etc. A document, when stored as data, has a file size measured in bytes. IaaS providers bill their customers for data storage according to the number of bytes stored for a given period of time. When a file is later accessed by a user in an IaaS environment the file must be read from a storage device (resulting in IOPS or disk I/O charges) and then transmitted across a network to the user (resulting in network bandwidth charges).

### Detailed Description of Some Embodiments

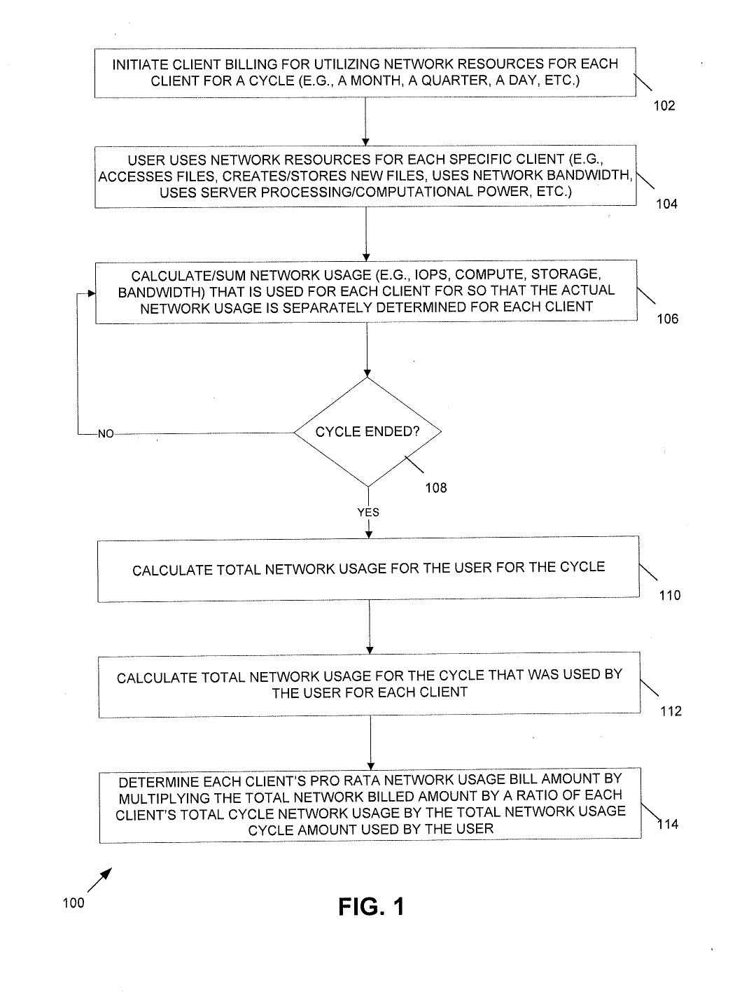

FIG. 1 is a flow chart illustrating an overview of a method 100 for discrete client billing according to one embodiment. In block 102, the discrete client billing for utilizing network resources for each client for a billing cycle (e.g., a month, a day, a quarter, etc.) is initiated. This may be accomplished by installing the software and systems and executing such software and systems to enable the processors thereof to execute one or more embodiments described herein. When initiated, this will allow a user of the software and systems herein to track information technology resources for each specific client.

In block 104, a user uses one or more network resources for each specific client. For example, the user may access files, create new files, store files, use network bandwidth, use server processing/computational power, and/or perform any other operations where information technology resources which are eventually billed to the firm/company or otherwise are expenses of the firm/company.

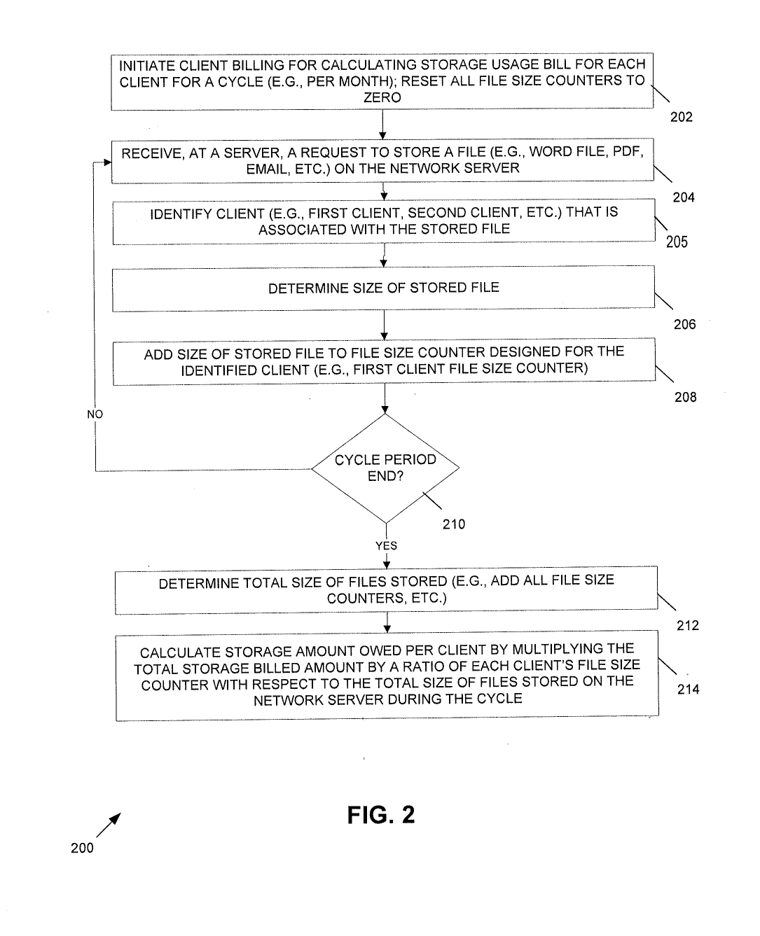

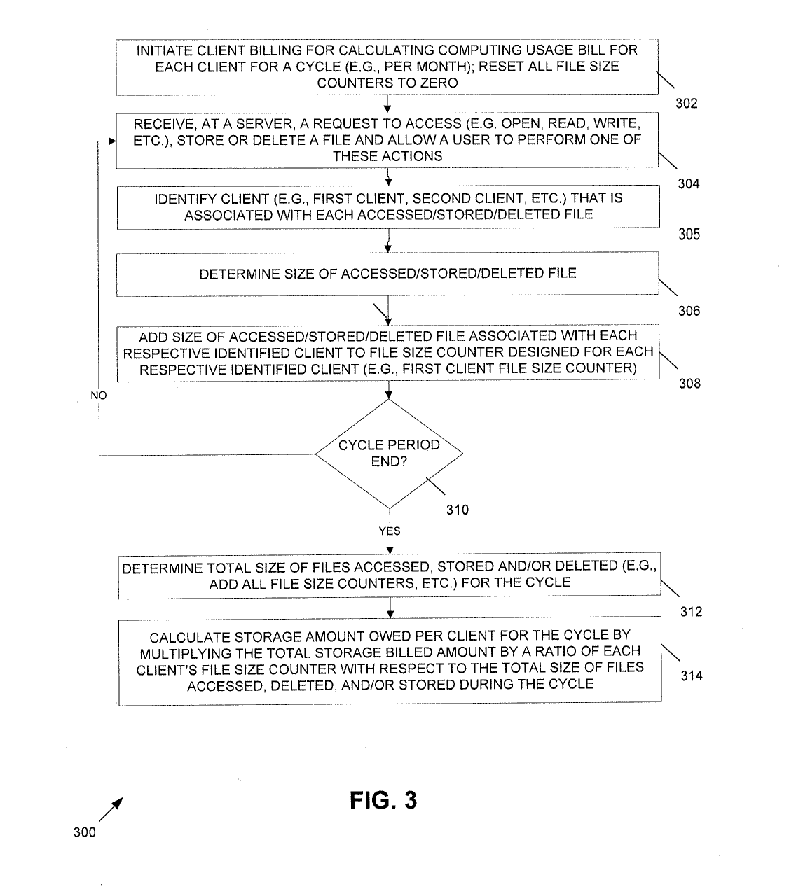

In block 106, a network resource (such as one or more of IOPS, computing, storage, or bandwidth resources) that is used for each client is calculated so that the actual network usage is separately determined for each client. The particular calculations in some embodiments are described below (and particularly with reference to FIGS. 2-3).

In block 108, it is determined whether the cycle has ended or not. If not, the method 100 may proceed back to block 106 where the network usage per client is continuously calculated (e.g., added) during the billing cycle. If the billing cycle has been determined to have ended in block 108, the method may continue 100 to block 110.

In block 110, the total network usage for the user for the cycle is calculated or otherwise determined. This total network usage amount is not separated into per client amounts but instead is all of the client usage amounts summed together.

In block 112, the total network usage for the cycle that was associated for each specific client is determined for each network resource. For example, for client A, the total network storage resource is determined that client A is associated with. In other words, a total network storage amount for files accessed for client A is determined. Also, a total network compute amount performed for items associated with client A is determined.

This provides the firm/company each client's pro rata percentage of the total network usage of the firm/company so that the firm/company can then calculate each client's pro rata amount of the expense.

In block 114, each client's pro rata network usage bill amount is determined by multiplying the total network billed amount by a ratio of each client's total cycle network usage by the total network usage cycle amount used by the user. For example, if client A's total network usage cycle amount used is 3% of the total network cycle usage and the total bill for the cycle is $3000, then client A's total pro rata share is $90, which could be billed to the client.

It is noted that the terms “network usage” and “information technology usage may be referred to herein as the same type of usage. Also, it should be understood that the term “user” may be one user or multiple users of a firm/company.

The below discussion begins a more detailed description of some embodiments of the present application. As mentioned above, the information technology usage may be sub-divided into particular types of information technology usage, such as storage usage, compute usage, IOPS usage, and bandwidth usage, because a firm's bill may be separated into sub-groups of information technology. FIGS. 2-3 illustrate examples of calculating a client's pro rata share of a bill of sub-groups of information technology. It should be noted that these are merely exemplary methods of calculating these sub-groups.

As provided below, the calculation amount may not be based on the actual usage but is an approximation based on the sizes of files (each of which are associated with a client ID) created, deleted, read, stored, and otherwise accessed by a user. It should be understood that the present application could use actual information technology usage rather than an approximation of the usage based on file sizes.

FIG. 2 is a flow chart illustrating a method 200 for discrete client billing of storage usage according to one embodiment. In block 202, client billing for calculating a storage usage bill per client per cycle is initiated, similar to block 102. Also, all file size storage counters for each client is reset to zero.

In block 204, the server receives a request to store a file on the network server. The server will then accept the request and in turn, the server to obtain client information (e.g., client name, identification (ID), etc.) associated with the requested file.

In block 205, the server identifies the client that is associated with the requested file, such as by identifying the client ID. The client will store the file (either before, during or after the operations in block 205).

In block 206, the size of the stored file is determined by the server. This may be accomplished by the server accessing the file or accessing data associated or pre-stored with the file.

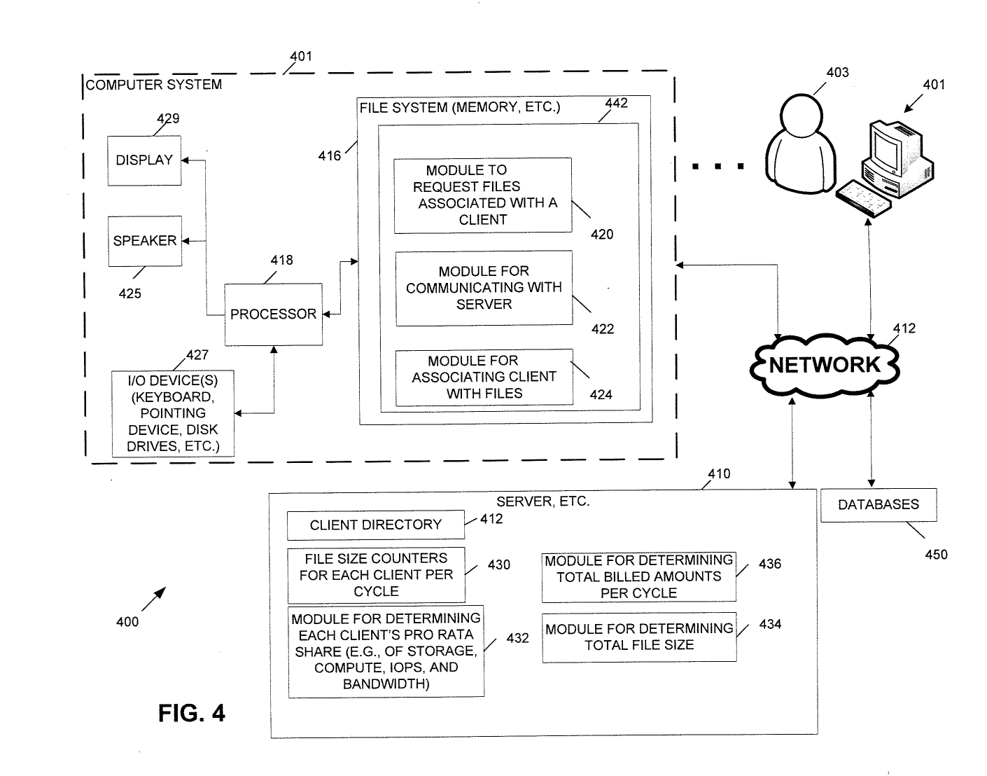

As is described below with regard to FIG. 4, there may be file size counters that keep a tally of the total amount of file size per a predetermined time (e.g., per day) per cycle (e.g., per month). Each file size counter is different for each client and each client may have different file size counters for each sub-group (e.g., storage, compute, IOPS, bandwidth, etc.) that the firm wishes to track.

In block 208, the client's file size counter is incremented by the file size of the stored file. For example, for client X that current has a file size counter that has been incremented to 112 GB, a file size that the user stores a 1 GB file for client X causes the server to increment the file size counter to 113 GB. This process occurs for each respective client and each file size counter is separately maintained for each client.

In block 210, the system determines whether the cycle period has ended. For example, if the cycles are monthly and if the monthly cycle has not ended, then the method 200 returns to block 204 to continue to store files and increment the file size counter in response thereto for each client. When the cycle has been determined to have ended, the method 200 continues to block 212.

In block 212, the total size of files stored for the cycle is identified or determined. In one embodiment, all of the file size counters of all clients may be summed to determine the total file size for all clients for the cycle. In another embodiment, the total file sizes of all files including files that have been stored on the network is used as the total file size.

In block 214, the total amount owed for each client for storage usage for the cycle is determined. In other words, each client's pro rata share of the user's storage usage bill for the cycle is determined. This may be accomplished by multiplying the total storage usage bill for the user times a ratio of each respective client's file size counter for the cycle (based on block 208) over the total file size for the cycle (based on block 212). For example, if client A's total file size for the cycle is 100 GB and the total files stored for the firm for the cycle is 500 GB and the cycle's storage bill is $5000, then the total storage amount owed for that cycle is $1000 (=$5000×(100 GB/500 GB)).

It should be noted that the ratio of each respective client's file size counter for the cycle (based on block 208) over the total file size for the cycle (based on block 212) may be used to calculate other information technology usage, such as the IOPS or bandwidth usage.

FIG. 3 is a flow chart illustrating a method for discrete client billing of computing usage according to one embodiment.

In block 302, client billing for computing usage is initiated, similar to block 102. Also, all file size computing counters for each client is reset to zero.

In block 304, the server receives a request to access (e.g., open, read, write, delete, etc.) a file stored on the network server. The server will then accept the request and in turn, the server to obtain client information (e.g., client name, identification (ID), etc.) associated with the requested file.

In block 305, the server identifies the client that is associated with the requested file, such as by identifying the client ID. The client will then permit the requested access to the file (either before, during or after the operations in block 305).

In block 306, the size of the requested file that is accessed is determined by the server. This may be accomplished by the server accessing the file or accessing data associated or pre-stored with the file.

In block 308, the client's file size counter is incremented by the file size of the file that is accessed. For example, for client X that current has a file size counter that has been incremented to 200 GB, a file size that the user accesses a 2 GB file for client X causes the server to increment the file size counter to 202 GB. This process occurs for each respective client and each file size counter is separately maintained for each client.

In block 310, the system determines whether the cycle period has ended. For example, if the cycles are monthly and if the monthly cycle has not ended, then the method 300 returns to block 304 to continue to receive requests and allow for accessing files and increment the respective file size counters in response thereto for each respective client. When the cycle has been determined to have ended, the method 300 continues to block 312 to calculate each client's pro rata share for computing for the cycle.

In block 312, the total size of files that have been accessed for the cycle is identified or determined. In one embodiment, all of the file size counters of all clients may be summed to determine the total file size for all clients for the cycle. In another embodiment, the total file sizes of all files including files that have been accessed on the network is used as the total file size.

In block 314, the total amount owed for each client for computing usage for the cycle is determined. In other words, each client's pro rata share of the user's storage usage bill for the cycle is determined. This may be accomplished by multiplying the total storage usage bill for the user times a ratio of each respective client's file size counter for the cycle (based on block 308) over the total file size for the cycle (based on block 312). For example, if client A's total file size for the cycle is 50 GB and the total files stored for the firm for the cycle is 250 GB and the cycle's storage bill is $500, then the total storage amount owed for for client A for that cycle is $100 (=$500×(50 GB/250 GB)). Thus, the firm can then bill client A for $100 and also bill all other clients their pro rata share to recover the $500 expense (or at least a large portion thereof)

It should be noted that the ratio of each respective client's file size counter for the cycle for computing (based on block 308) over the total file size for the cycle (based on block 312) may be used to calculate other information technology usage, such as the IOPS or bandwidth usage. This ratio would then be applied in a similar manner against the bill or expense for the IOPS or bandwidth usage so that the firm can then bill the clients for IOPS and/or bandwidth pro rata shares.

FIG. 4 is a block schematic diagram of a system 400 for discrete client billing according to one embodiment. System 400 may include a software module 442 operable on a computer system 401, or similar device of a user 403 or client. System 400 also includes a discrete client billing system module operable on a server 410 (hereinafter “server discrete client billing system module”) at and/or controlled by a managing entity. The managing entity is an entity which manages the discrete client billing system software and provides this software on a network for users to access and use.

Server 410, including database 450 (and also optionally computer system 401), may be considered the term “system” as used herein. Server 410 is accessible by computer system 401 via a network 412 such as the Internet. One or more of the methods discussed herein may be embodied in or performed by software module 442 and/or server discrete client billing system module, alone or in conjunction with a user. That is, some of the features or functions of the presently described methods may be performed by software module 442 on computer system 401, and other features or functions of the presently described methods may be performed on server discrete client billing system module. In another embodiment, all of the features or functions of the presently described methods may be performed by server 410 or computer system 401.

Database 450 may be operable on server 410 or may be operable separate from server 410 and may be communicable by users 403 using their respective computer systems 401 or clients. Database 450 includes various data including client identification information, stored files that the user can access, and any other information that is usable by the system and/or the user.

Network 412 is a network of the firm or company and may be used by computer 401 to access server 410 or any other device on network 412. Each computer system on the network may be similar to the exemplary computer system 401 and associated components illustrated in FIG. 4.

Each software module 442 and/or server discrete client billing system module may be a self-contained system with embedded logic, decision making, state based operations and other functions that may operate in conjunction with collaborative applications, such as web browser applications, email, telephone applications and any other application that can be used to communicate data, files, etc. with an intended user. Users may utilize the self-contained systems as part of a process of accessing, creating, reading, and deleting files or other content on the network 412.

Software module 442 may be stored on a file system 416 or memory of the computer system 401. Software module 442 may be accessed from file system 416 and run on a processor 418 associated with computer system 401.

Software module 442 includes various modules that perform steps as discussed herein. Software module 442 may include a module to interface or communicate with the server 422 (hereinafter “server interface module”). The server interface module 422 allows for interfacing with modules on server 410 and communicates with server 410 to upload and/or download requested data and other information. As such, computer 401 may act as both a requesting device and an uploading device. Additionally, the server interface module allows for transmission of data and requests between the computer 401 and server 410. For example, the server interface module allows for a query message to be transmitted to the server for requesting a file and also allows for receipt of the results or the file content. The server interface module distributes data received to the appropriate server module for further processing.

Any query may take the form of a command message that presents a command to the server, which in turn compiles the command and executes the requested function, such as retrieving information from database 450.

Software module 442 may also include graphical user interfaces (“GUIs”), as previously presented. Software module 442 may present one or more predetermined GUIs to permit the user to input/select data into the system, direct computer 401 to perform certain functions, define preferences associated with the query, or allow the user to input any other information and/or settings. The GUIs may be predetermined and/or presented in response to the user attempting to perform operations (such as those described previously in FIGS. 1-3), queries or enter information and/or settings. Discrete client billing system module may generate the predetermined GUIs, which may be presented to the user on a display 429 of computer system 401. The GUIs also presents users notifications. The GUIs may allow the user to custom define a query or input a client/matter identification number. The GUIs can be custom-defined and execute in conjunction with other modules and devices on the user's computer 401, such as I/O devices 427, the module to interface with the server 422, or any other module.

User computer system 401 may also include a display 429 and a speaker 425 or speaker system. Display 429 may present applications for electronic communications and/or data extraction, uploading, downloading, creating documents, accessing documents, etc. and may perform controlling and display of the data in the requested files, notifications, etc. as described herein. Any GUIs associated with discrete client billing system module and application may also be presented on display 429. Speaker 425 may present any voice or other auditory signals or information to user 403 in addition to or in lieu of presenting such information on display 429.

User computer system 401 may also include one or more input devices, output devices or combination input and output device, collectively I/O devices 427. I/O devices 427 may include a keyboard, computer pointing device, or similar means to control operation of applications and interaction features described herein. I/O devices 427 may also include disk drives or devices for reading computer media, including computer-readable or computer-operable instructions.

As noted above, server discrete client billing system module may reside on server 410. It should be understood that server discrete client billing system module may also, or alternatively, reside on another computer or on a cloud-computing device. One or more of the sub-modules of the server discrete client billing system module may all run on one computer or run on separate computers.

Software module 442 may also include a module 422 to interface with the server (hereinafter “server interface module”). Server interface module 422 allows for interfacing with modules on server 410 and communicates with server 410 to upload and/or download requested data and other information. As such, computer 401 may act as both a requesting device and an uploading device. Additionally, server interface module 422 allows for transmission of data and requests between the computer 401 and server 410. For example, server interface module 422 allows for a query message to be transmitted to the server and also allows for receipt of the results. Server interface module 422 distributes data received to the appropriate module for further processing.

Server discrete client billing system module includes graphical user interfaces (“GUIs”). Server discrete client billing system module may present one or more predetermined GUIs to permit the user to input/select data, direct computer 401 to perform certain functions, define parameters associated with the search query (e.g., client/matter identification number, etc.), request a particular file, and/or allow the user to input any other information and/or settings. GUIs may be predetermined and/or presented in response to the user attempting to perform a query or enter information and/or settings. Server discrete client billing system module generates the predetermined GUIs, which may be presented to the user on a display 429 of computer system 401. GUIs also present users notifications. GUIs allow the user to custom define a query, such as changing a changing a query's search parameters. GUIs can be custom-defined and execute in conjunction with other modules and devices on the user's computer 401, such as I/O devices 427, the module to interface with the server 410, or any other module. The GUIs are generated by server 410 and allow the user to access the GUI using a web browser to enter data on the GUI through a software as a service (“SaaS”), IaaS, or other application programming interface (“API”). Thus, when the user enters data on the GUI, server discrete client billing system module stores the data in managing entity database 450.

Server discrete client billing system module also includes a module or modules to query databases, such as the module 420 to request files associated with a client (hereinafter “request module”). Request module 420 allows a user to query data on server 410 and, thereby, from managing entity database 450 or from other databases. The query may take the form of a command message that presents a command to the server 410, which in turn compiles the command and executes the requested function, such as retrieving information from database 450 or another database. Request module 420 communicates with server 410 to upload a query and/or file, to download requested items (e.g., files/emails, etc.), or to otherwise modify items via server interface module 422. When performing such operations the request module may work with the module 424 to associate client ID with files 424 so that a newly-created file, for example, is associated with a client ID for billing purposes.

After transmission of a query message and retrieval of the query results, request module 420 may store the retrieved data in the memory for future retrieval and the file size counter 430 increments a file size counter associated with the client ID that corresponds to the files accessed as previously described in FIGS. 2-3.

Database(s) 450 are connected to network 412 so that server 410 can retrieve information therefrom. Database(s) 450 may be databases managed by the firm/company on server 410 to access client ID information for particular files and to store any of the data on the server, such as file size counters 430, client directory 412, etc. Server 412 is therefore able to query the database(s) 450 for data regarding files, client information and information technology usage (including file size counters).

The client directory 412 may include a listing of client names and client identifiers (IDs) for each respective client. This allows a user or the system to associate a file that is newly created (or existing files) with a client ID. In this regard, all files can be associated with a client ID so that when a file is assessed in any way, the system can know when each client ID file size counter should be incremented as detailed in FIGS. 2-3.

The file size counters 430 are counters or data that keeps track of a total amount of information technology usage for each client. In one embodiment, each client has a different file size counter from each other. For example, client A has a client A file size counter which keeps track of the total pro rata share of client A. Additionally, each client may have multiple file size counters—one for each information technology category. For example, client A may have a client A file size storage counter that keeps track of client A's file size storage usage as well as file size counters for computing usage tracking, IOPS usage tracking, bandwidth usage tracking, or other information technology usage to keep track of each aspect of information technology that the system wishes to determine each client's pro rata share of information technology for a particular firm/company.

The server discrete client billing system module may further include other modules, including a module 432 for determining each client's pro rata share of information technology, a module 436 for determining the total billed amounts per cycle, and module 434 for determining a total file size.

The module 436 for determining the total billed amounts per cycle calculates or identifies the total amounts billed to the firm/company. Such information is then stored on the database 450 or server 410.

The module 434 for determining a total file size performs one or more functions of FIGS. 1-3 in calculating each client's pro rata total share of the total amount of information technology used by the firm/company per cycle.

The module 432 for determining each client's pro rata share of information technology calculates each client's pro rata total share of the total amount billed to the firm/company per cycle. Such module 432 receives data from the other modules in the computer and/or server in performing such calculations, including the module 436 for determining the total billed amounts per cycle and the module 434 for determining a total file size.

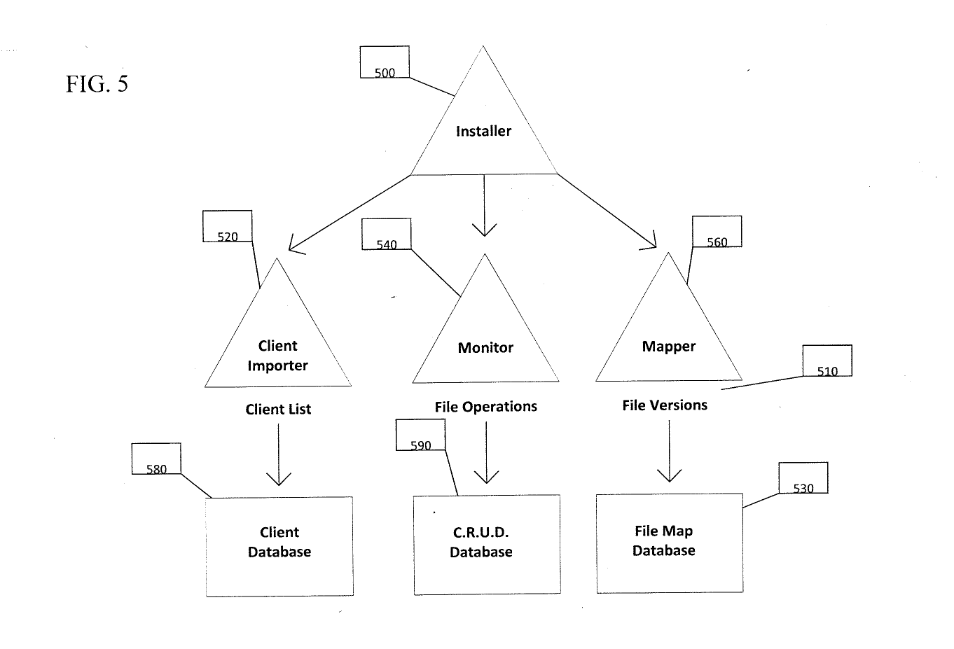

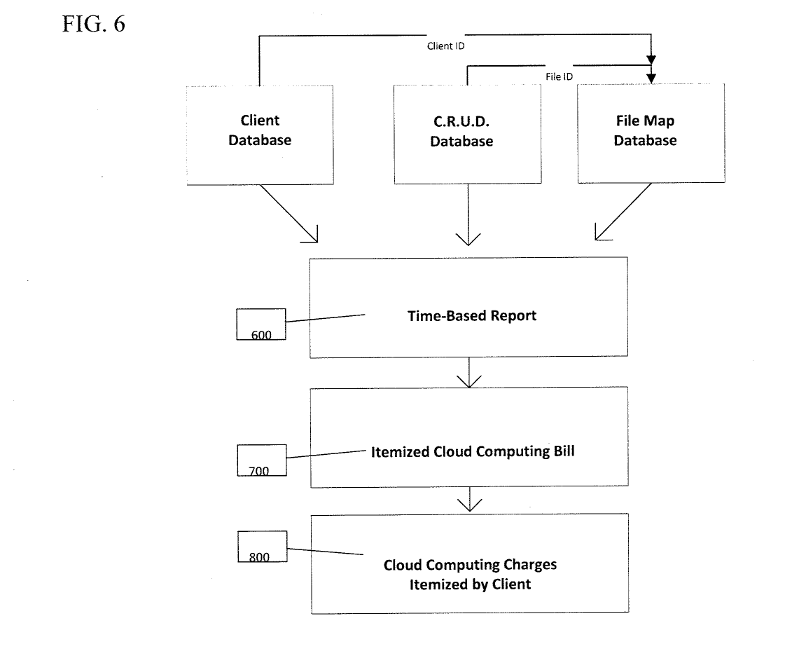

FIG. 5 is another system diagram for discrete client billing according to one embodiment, and FIG. 6 is a diagram illustrating a combination of a method and system for discrete client billing according to one embodiment. These Figures are discussed below. FIG. 5 may be implemented into FIG. 4 and FIG. 6 may also be implemented into the methods of FIGS. 1-3.

As mentioned above, there are two mechanisms by which an allocation method could be achieved:

1—A database query at the end of a billing period: Each document within a DMS is indexed according to client, matter, and file size. A DMS will record the date and time each file is accessed as well as the client to which the file is associated. It is possible to query the DMS data at the end of each billing period to determine the total of all file sizes stored for a particular client and the total of all file sizes read from the data store and transmitted across the network during a time period, thus resulting in a client's total bandwidth and storage costs. Since file size and number of times accessed will be determinative of IOPS it is reasonable to allocate IOPS to a client based on the total bandwidth associated with that client. It is also reasonable to allocate a proportionate amount of the total time used on an AWS server instance during the time period.

2—AWS allows for auto provisioning of storage “buckets” on their “S3” storage product by means of an Automated Programming Interface (API) call. By the same mechanism, these buckets may be tagged for billing purposes. Some DMSs allow for the segregation and storage of documents in distributed folders or directories. In this mechanism, the software interface would devise a distributed folder storage structure to segregate a firm's client files. Each client would also be provisioned for its corresponding folder a discrete S3 bucket that is tagged with an AWS billing tag. At the creation of a new client within the DMS, the software interface would create a new folder, simultaneously auto-provisioning a tagged S3 storage bucket on AWS. Each time that client's files are accessed or edited, the bandwidth used to transmit these files to the user is measured and allocated to the corresponding bucket tag along with the costs of storage associated with documents in that bucket for billing purposes. Using the tagged bandwidth and storage charges, a proportionate allocation of the server instance charges would be calculated to compute a total billable amount of cloud computing charges to the client for the time period.

Since the method described above is to be the intellectual property on which a potential business may be based the partners in the potential business are seeking the most efficacious legal means of protecting this intellectual property from unauthorized use.

Referring now to FIGS. 5-6, FIG. 5 is a system diagram for discrete client billing according to one embodiment. An installer 500 installs three primary modules: Importer, Monitor and Mapper. The client importer 520 imports client information from user's list in any format to client database. Client database 580 (or the client directory) contains records for client, client ID, matter, and matter ID. Monitor 540 monitors computer's operating system for file operations (create, read, update, delete, or other forms of file access). When operation occurs, monitor stores record of the C.R.U.D. to C.R.U.D. database.

C.R.U.D. database 590 contains records for date, time, file ID, and file size at the time of the C.R.U.D. Mapper 560 associates files to clients by activating I.D. capture at the point of creating any computer file. Also, at the point of sending or opening an email, mapper launches I.D. capture to associate client with email address for future emails.

File versions 510 includes every version of every computer file and email. It should be understood that any type of file or data may be used when referring to “file” herein and the present application should not be limited to certain files. Thus, files may mean files stored in WORD format, PDF format, or any other format, emails stored, or event any other data stored.

File map database 530 contains records of file ID, file version ID, matter ID and client ID. Each of the databases may be connected to network 512 (FIG. 4) and be in communication with the server.

FIG. 6 is a flow chart illustrating a method for discrete client billing according to one embodiment. As shown databases are accessed to create a time-based report. In step 900, at the end of a time period, a report will sum the file sizes in bytes by client ID for all file operations during the period. A percentage of the total bytes will be apportioned to each client ID.

At step 600, the firm/company receives a bill from cloud provider (or other entity) itemizing charges for computing, storage, bandwidth and Input/Output (IOPS) operations, as previously discussed with reference to FIGS. 1-3.

At step 700, the client percentage above will be used to allocate each client's proportionate share of cloud computing costs, including compute, storage, bandwidth, and Input/Output Operations, as previously discussed with reference to FIGS. 1-3.

The flowcharts and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to embodiments of the invention in the form disclosed. Many modifications and variations will be apparent to those of ordinary skill in the art without departing from the scope and spirit of embodiments of the invention. The embodiment was chosen and described in order to best explain the principles of embodiments of the invention and the practical application, and to enable others of ordinary skill in the art to understand embodiments of the invention for various embodiments with various modifications as are suited to the particular use contemplated.

Although specific embodiments have been illustrated and described herein, those of ordinary skill in the art appreciate that any arrangement which is calculated to achieve the same purpose may be substituted for the specific embodiments shown and that embodiments of the invention have other applications in other environments. This application is intended to cover any adaptations or variations of the present invention. The following claims are in no way intended to limit the scope of embodiments of the invention to the specific embodiments described herein.

What is claimed is:

1. A method for discrete client billing, the method comprising:
receiving, at a server, a request to perform an action for each of a plurality of files on a network of an entity, wherein the action comprises at least one of accessing, reading, writing, updating, creating, deleting and/or storing one or more files;
identifying, at the server, a first client associated with the plurality of files;
summing, at the server, the file sizes of the plurality of files that the action has been performed only for the first client during a predetermined cycle, resulting in a first client total file size;
determining a second total file size of files that the action has been performed by the entity associated with the first client and other clients during a predetermined cycle; and
determining a pro rata share of network usage for the first client using a ratio of the first client total file size over the second total file size.

2. The method of claim 1, further comprising:
identifying a total bill amount for the entity; and
determining the first client's pro rata bill amount by multiplying the total bill amount times the first client's pro rata share.

3. The method of claim 1, further comprising:
identifying a second client associated with a second plurality of files;
determining a total file size of the second plurality of files associated with the second client during the predetermined cycle; and
determining the second client's pro rata share of network usage using a ratio of the total file size of the second plurality of files associated with the second client over the total amount file size accessed or stored during the cycle.

4. The method of claim 3, further comprising:
identifying a total bill amount for the entity; and
determining the second client's pro rata bill amount by multiplying the total bill amount times the second client's pro rata share.

5. The method of claim 1, wherein the network usage comprises one of a storage usage, computing usage, IOPS usage, or bandwidth usage.

6. The method of claim 1, wherein each file comprises one of: a document, an email, a website, or a data item.

7. A system for discrete client billing, the system comprising:
a database;
a memory; and
a processor configured for:
receiving, at a server, a request to store a first file on a network of an entity;
identifying a first client associated with the first file;
identifying a first file size counter associated with the first client;
receiving a request to store a second file on the network of the entity;
identifying that the first client is associated with the second file;
determining a first file size and second file size of the second file associated with the first client;
incrementing the first file size counter by the first file size and the second file size in response to determining that the first and second file sizes are associated with the first client;
determining the first client's pro rata share of network usage using a ratio of the first file size counter of the first client over a total amount file size stored for all clients by the entity during the cycle.

8. The system of claim 7, further comprising:
receiving, at a server, a request to store a third file on the network of the entity;
identifying a second client associated with the third file;
determining a third file size of the third file associated with the second client;
identifying a second file size counter associated with the second client;
incrementing the second file size counter by the third file size in response to determining that the third file sizes is associated with the second client; and
determining a pro rata share of network usage of the second client using a ratio of the second file size counter of the second client over a total amount file size stored for all clients by the entity during the cycle, wherein the al amount file size stored for all clients comprises the first, second and third file sizes.

9. The system of claim 8, further comprising:
identifying a total bill amount for the entity; and
determining the second client's pro rata bill amount by multiplying the total bill amount times the second client's pro rata share.

10. The system of claim 7, further comprising:
identifying a total bill amount for the entity; and
determining the first client's pro rata bill amount by multiplying the total bill amount times the first client's pro rata share.

11. A method for discrete client billing, the method comprising:
receiving, at a server, a request to use network resources a network of an entity, wherein the action comprises at least one of access, read, write, update, create, delete and/or store the file, and wherein network usage is an expense to the entity;
identifying a first client associated with the network use request;
determining a total amount of network usage being performed for the first client during a predetermined cycle; and
determining a pro rata share of network usage for the first client during the cycle by based on a ratio of the total amount of network usage being performed for the first client during the cycle over a total amount of network usage being used by the entity during the cycle.

12. The method of claim 11, further comprising:
identifying a total bill amount for the entity for network usage; and
determining the first client's pro rata bill amount by multiplying the total bill amount times the first client's pro rata share.

13. The method of claim 11, further comprising:
identifying a second client associated with a second plurality of files;
determining a total file size of the second plurality of files associated with the second client during the predetermined cycle; and
determining the second client's pro rata share of network usage using a ratio of the total file size of the second plurality of files associated with the second client over the total amount file size accessed or stored during the cycle.

14. The method of claim 13, further comprising:
identifying a total bill amount for the entity; and
determining the second client's pro rata bill amount by multiplying the total bill amount times the second client's pro rata share.

15. The method of claim 11, wherein the network usage comprises one of a storage usage, computing usage, IOPS usage, or bandwidth usage.

16. The method of claim 11, wherein each file comprises one of: a document, an email, a website, or a data item.
